(19) United States
(12) Patent Application Publication
(10) Pub. No.: US 2009/0013921 A1
(43) Pub. Date: Jan. 15, 2009

(54) Decorative outdoor home flag kit

(76) Inventor: Hua Yun, Diamond Bar, CA (US)

Correspondence Address: DAVID AND RAYMOND PATENT FIRM, 108 N. YNEZ AVE., SUITE 128, MONTEREY PARK, CA, 91754, US

(21) Appl. No.: 11/827,864

(22) Filed: Jul. 12, 2007

(51) Int. Cl. G09F 17/00; B65D 69/00

(52) U.S. Cl. 116/173; 206/223; 206/575

(57) ABSTRACT

A decorative home flag kit having a flag sheet which has a front side displaying a decorative graphic wherein the decorative graphic is being printed on the front side and is displayed in a reverse manner without any noticeable lost of image sharpness and color density on a rear side of the flat sheet which communicatively couples with the front side, and a flag sleeve disposed at an edge of the flag sheet. The decorative home flag kit further has a flag support frame for suspending the flag sheet which has a suspending arm having an engaging hook which is adapted to engage with the flag sleeve of the flag sheet such that the suspending arm can be inserted into and enclosed by the flag sleeve, an extending member coupling with the suspending arm and a mounting base coupling with the extending member for mounting.

### BACKGROUND OF THE PRESENT INVENTION

1. Field of Invention

The present invention relates to a home flag kit, and more particularly to a decorative outdoor home flag kit which economically affordable to make, easy to install, easy to package for sell, while achieving the same decorative result.

2. Description of Related Arts

Conventional home flag kit can be usually divided into two types. The first type is for a home flag which is usually suspended by using a pole extending away from a vertical wall. The second type is for a garden flag which is usually suspended on a horizontal pole which connects to another pole extending vertically from the garden ground in a house yard. Such conventional home flag kit comprises a flag which has a front and a rear side with graphics thereon for decorative displaying purposes, a base for mounting on a wall or house yard depending on the flag type, a pole-like object coupling with the base which is adapted for suspending the home flag.

Such conventional home flag has a disadvantage in displaying its decorative purpose. Since there is at least two sides to a flag, two separated printings are required to be applied both side on the flag if the user wishes to be displaying decorative graphics on both sides of the flag. The printing process and chemical materials involved are often found to be one of the most expensive processes of making such conventional home flag kit. In addition, printing on both sides of the flag requires more industrial caring such as allowing the chemical to dry. Also the printing might even defect the decorative graphics on the other side of the flag as well.

Another disadvantage of such conventional home flag kit is that they are often hard to be carried at a pre-installed stage. Since the home flag is for decorative display purpose, the flag is usually large in size. The length of the pole for suspending the flag must be longer than the length of the flag. Therefore, the pre-installed home flag kits are usually lengthy in size. It is very inconvenient for transportation and installation of such conventional home flag kits. Many of the conventional home flag kit frames are made of wood and steel structure and they are found to be heavy and expensive.

The conventional home flag kits are usually expensive and many families are not willing to spend that amount of money to decorate the house. Therefore, a cheaper flag kit is always in demand.

### SUMMARY OF THE PRESENT INVENTION

The main object of the present invention is to provide a decorative outdoor home flag kit which has a decorative flag sheet with decorative graphics on a front and rear side of the flag sheet with only a single flat screen printing without any noticeable lost of image sharpness and color density.

Another object of the present invention is to provide a decorative outdoor home flag kit which the flag sheet can be conveniently, detachably and stably suspended for its decorative purpose.

Another object of the present invention is to provide a decorative outdoor home flag kit which is easy to be installed.

Another object of the present invention is to provide a decorative outdoor home flag kit which can be packaged into a flag package at a preinstalled stage such that the display rating of such flag package can be enhanced and the home flag kit can be selected by customers easily.

Another object of the present invention is to provide a decorative outdoor home flag kit which can be packaged into a flag package at a preinstalled stage such that the transportation of such flag package is very convenient and time efficient.

Another object of the present invention is to provide a decorative outdoor home flag kit which does not involve complicated mechanical structure which can reduce the manufacture cost.

Another object of the present invention is to provide a decorative outdoor home flag kit which is cheap to make and is easily affordable by family for decorative purposes to encourage a social effect of beautifying our homes and environment.

Accordingly, in order to accomplish the above objects, the present invention provides a decorative outdoor home flag kit, comprising:

a flag sheet which comprises a front side displaying a decorative graphic wherein the decorative graphic is being printed on the front side by a flat screen printing method and is displayed in a reverse manner without any noticeable lost of image sharpness and color density on a rear side of the flat sheet which couples with the front side, and a flag sleeve disposed at an edge of the flag sheet;

a flag support frame suspendedly supporting the flag sheet, wherein the flag support frame comprises a suspending arm slidadbly extended along the flag sleeve and an engaging hook detachably engaging with the flag sleeve of said flag sheet so as to support the flag sheet at the suspending arm; and

an adapter coupling with the suspending arm for suspendedly supporting the flag sheet in the air.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the decorative outdoor home flag kit according to the preferred embodiment of the present invention.

FIG. 2A is a perspective view of the flag sheet illustrating the decorative graphic on the front side.

FIG. 2B is a perspective view of the flag sheet illustrating the decorative graphic on the rear side.

FIG. 3 is a perspective view of the decorative outdoor home flag kit according to the alternative embodiment of the present invention for mounting on a wall.

FIG. 3A is a perspective view of the flag sleeve of the decorative outdoor home flag kit according to the alternative embodiment of the present invention.

FIG. 4 is a perspective view of the flag package according to the preferred embodiment of the present invention.

FIG. 5 is a sectional view of the flag package according to the preferred embodiment of the present invention.

### DETAILED DESCRIPTION OF THE PREFERRED EMBODIMENT

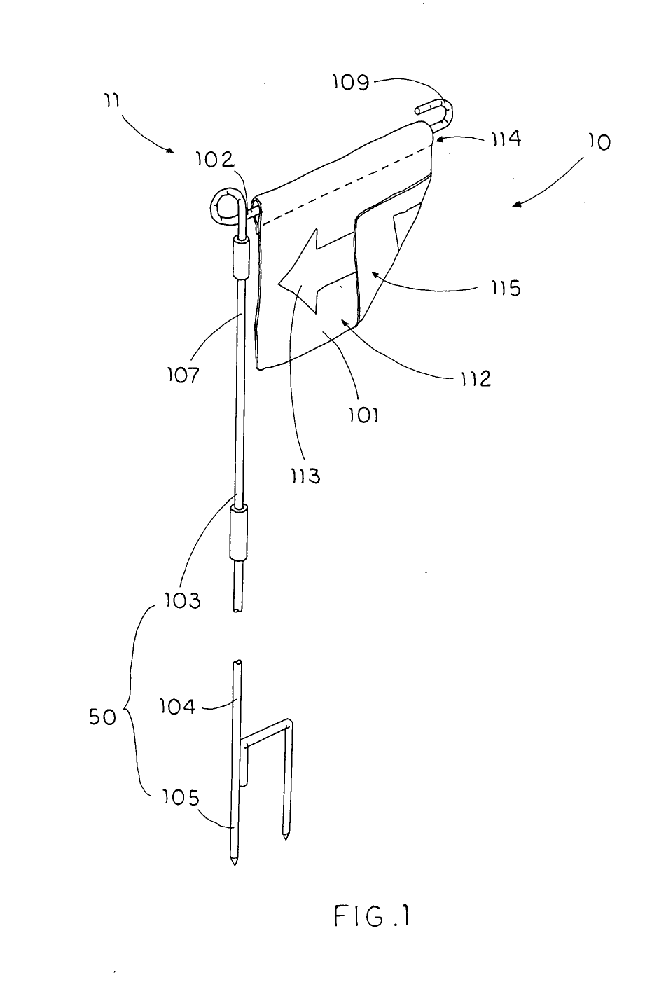

Referring to FIG. 1 of the drawings of the preferred embodiment of the present invention, a decorative outdoor home flag kit 10 comprises a flag sheet 101, a flag support frame 11 and an adapter 50. The flag support frame 11 comprises a suspending arm 102 for suspendedly supporting the flag sheet 101. The adapter 50 couples with the suspending arm 102 such that the flag sheet 101 is suspended in the air.

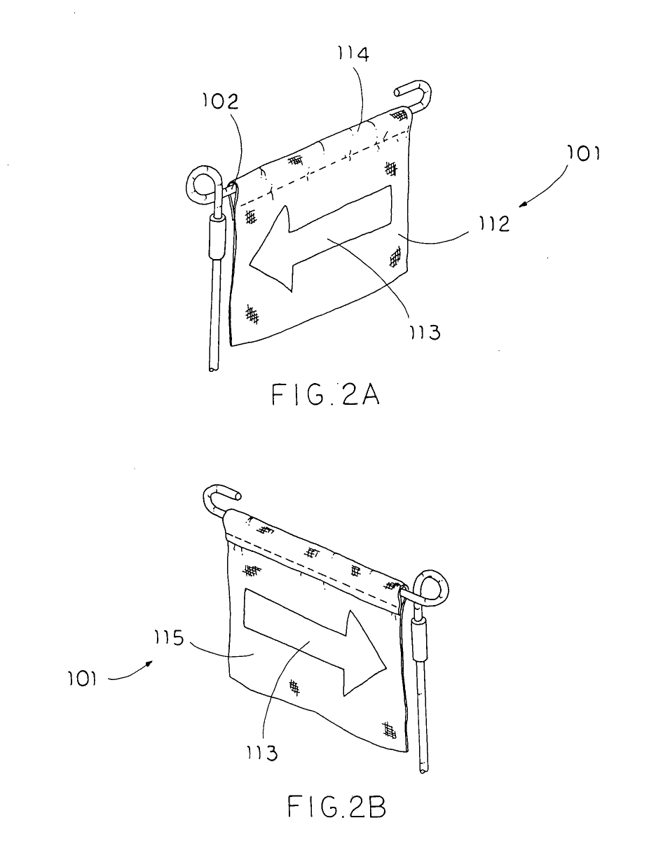

Referring to FIG. 2A of the drawings, the flag sheet 101 has a front side 112 displaying a decorative graphic 113. The flag sheet 101 further comprises a flag sleeve 114 disposed at an edge of the flag sheet 101 which is adapted for the suspending arm 102 to insert thereinto for suspending the flat sheet 101. According to the preferred embodiment of the present invention, the flag sheet 101 is made of tatting cloth and has an approximate weight density of 40-120 g/m², the decorative graphic 113 is printed on the flag sheet by a flat screen printing method. A permeation agent is used in the flat screen printing method such that the decorative graphic 113 can penetrate through the front side 112 and be displayed in a reverse manner on a rear side 115 of the flag sheet 101. FIG. 2b illustrates the rear side 115 of the flag sheet 101. According to FIG. 2b of the drawings, the decorative graphic 113 is in a reverse manner as printer on the front side 102. According to the preferred embodiment of the present invention, the usage of the flat screen printing method along with permeation agent on the specified tatting cloth allows the decorative graphic 113 to be printed on a front side 102 of the flat sheet 101 and to penetrate through the front side 112 and be displayed on the rear side 115 without any noticeable lost of image sharpness and color density. The flag sheet 101 has a typical width of 8 to 18 inches and a length of 10 to 25 inches.

Two kinds of the permeation agent can be used in the method mentioned above. A first kind of permeation agent is called JFC permeation agent which comprises fatty alcohol epoxy ethane and has a PH rate ranges from 5-7. The first kind of permeation agent also has a cloud point ≧40° C. and it is a slightly yellowish or colorless oily liquid. Approximately 0.1%-1% of this permeation agent is used in the flat screen printing method.

A second kind of permeation agent is called quick permeation agent T which comprises sulfonate dioctyl phthalate amber acid and it is a sticky liquid with a slightly yellowish and brownish color with a PH rate ranges from 6.0-7.0. Approximately 0.1%-1% of this permeation agent is used in the flat screen printing method. These kinds of permeation agent are very environment friendly and do no pollute our environment.

Referring to FIG. 1 of the drawings, the adapter 50 further comprises a mounting base 104 which has a U-shaped penetrating end 105 at an end thereof for penetrating to grass surface and an extending member 103. The mounting base 104 is a tubular shaped member and further comprises a receiving cavity disposed at another end thereof which has circular threads at an inner surface of the receiving cavity. The extending member 103 is a tubular shaped member which its length is longer than the height of the flat sheet 101. The extending member 103 further comprises an inserting element 107 disposed at both ends of the extending member 103. The inserting element 107 has circular threads and is adapted to detachably and rotatably attach with the receiving cavity of the mounting base 104. The suspending arm 102 is a tubular shaped member and further comprises the receiving cavity at an end also for detachably attaching with the inserting element 107 of the extending member 103. Referring to FIG. 1 of the drawings, the suspending arm 102 has a horizontal portion which extends along the flag sleeve 114, a vertical portion detachably coupling with the extending member 103, and a loop portion integrally extended from the horizontal portion to the vertical portion to reinforce a strength of the suspending arm 102 without involving any complicated mechanical structure. The horizontal length of the suspending arm 102 is longer than the width of the flag sheet 101 such that the suspended flag sheet 101 can be suspended and display the decorative graphic 113 in full. The suspending arm 102 further comprises an engaging hook 109 disposed at another end thereof which is a U-shaped hook structure. The engaging hook 109 of the suspending arm 102 is adapted to engage with the flag sleeve 114 of the flag sheet 101 such that the suspending arm 102 can be completely inserted into and enclosed by the flag sleeve 114 through the opening of the U-shaped hook structure. The engaging hook 109 provides a convenient way of inserting the suspending arm 102 into the flag sleeve 114 without involving any complicated mechanical structure. In addition, the U-shaped hook structure of the engaging hook 109 prevents the suspended flat sheet 101 from slipping out of the suspending arm 102.

The suspending arm 102, the extending member 103, and the mounting base 104 are made of steel since the material is very durable. The U-shaped penetrating end 105 of the mounting base 104 is designed to penetrate through garden yard such as soil ground thus a stiff durable material is required. The circular threads from the receiving cavity and inserting element 107 also require a durable material to prevent stripping of material over a long-term usage. The diameters of the tubular member of the suspending arm 102, the extending member 103, and the mounting base 104 are small in size thus the overall weight of them is low so that it is convenient for the transportation and installation process. The typical size of the diameter of the tubular member is about 0.35 to 0.7 cm.

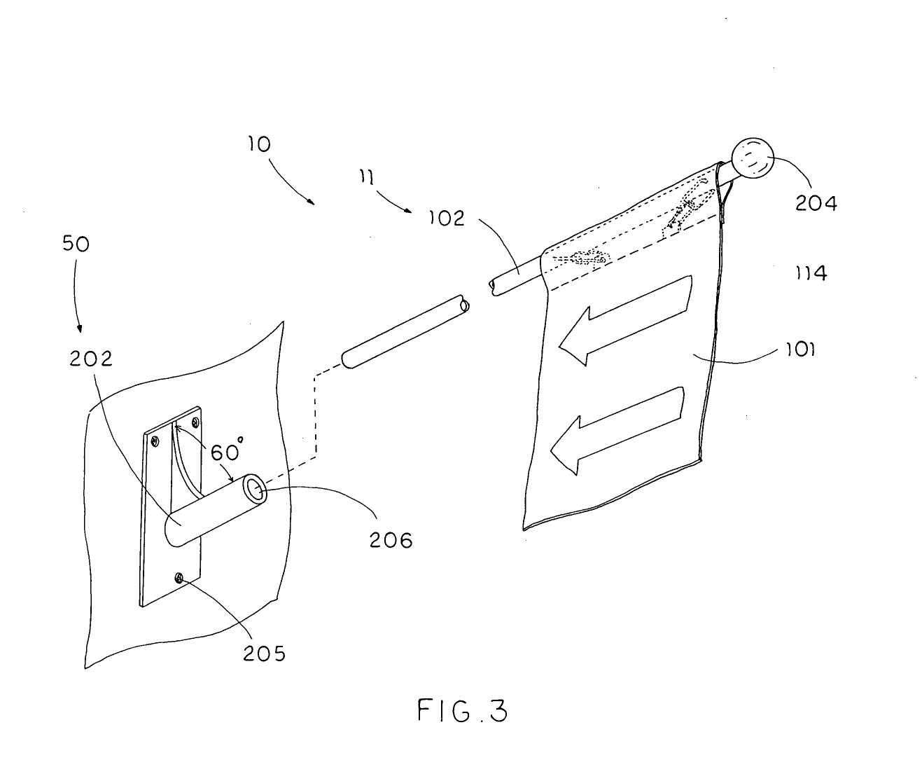

FIG. 3 of the drawings illustrates an alternative embodiment of the present invention for mounting on a house wall. The decorative outdoor home flag kit 10 comprises the flag sheet 101, the flag support frame 11, and the adapter 50. The flag support frame 11 comprises a suspending arm 102. The adapter 50 couples with the suspending arm 102 such that the house flag sheet 101 is suspended in the air.

Referring to FIG. 3A of the drawings, the house flag sheet 101 further comprises a plurality of attaching elements 216 extending outwardly from an edge of the flag sheet 101 receiving within the house flag sleeve 114. The plurality of attaching elements 216 is located at a corner of the flag sheet 101 and further comprises an attaching hole 217 for a stabilizing function. The suspending arm 102 further comprises a flag ring 208 which couples with a flag hook 209 disposed near an opening end 207 of the suspending arm 102 adapted for detachably attaching with the attaching hole 217 of the attaching elements 216 of the flag sheet 101 which prevents the flag sheet 101 from sliding along the suspending arm 102 while it is suspended. The flag ring 208 is attached on the suspending arm 102 through the attaching hole 217 near the opening end 207 of the suspending arm 102. The flag hook 209 is a hook made by metallic materials such that when the flag hook 209 is pressed inwardly, it creates a hooking cavity for users to attach the flag hook 209 with the attaching hole 217 of the attaching elements 216. A suspending pole cap 204 is fittedly adapted to detachably plug onto the opening end 207 of the suspending arm 102 such that the flag sheet 101 cannot slide out of the suspending arm 102.

Referring to FIG. 3 of the drawings, the adapter 50 further comprises a wall mount base 202 detachably coupling with the suspending arm 102 for mounting on a house wall so as to suspendedly support the flag sheet 101 with respect to the house wall. The wall mount base 202 comprises a plate which has a plurality of mounting holes 205 thereon adapted for using screws to mount on regular house wall. A receiving end 206, which has a hollow tubular structure extends outwardly from the plate at a 60 degree angle, is adapted for detachably attaching with the suspending arm 203 of the decorative outdoor home flag kit 10.

According to the alternative embodiment shown in FIG. 3 of the drawings, the wall mount bases 202, the suspending arm 102, and the suspending pole cap 204 are made of plastic materials since they are really light weight. The flag sheet 101 is usually large in size, thus requiring a long suspending arm 102. Since the suspending arm 102 is attached onto the wall mount base 202, the weight of the suspending arm 102, the house flag sheet 201, and the suspending pole cap 204 creates a bending moment at the wall mount base 202. Therefore, a lightweight material like plastic is an excellent choice. A reduce in overall weight of the decorative outdoor home flag kit 10 also provides a convenient transportation and installation process as well.

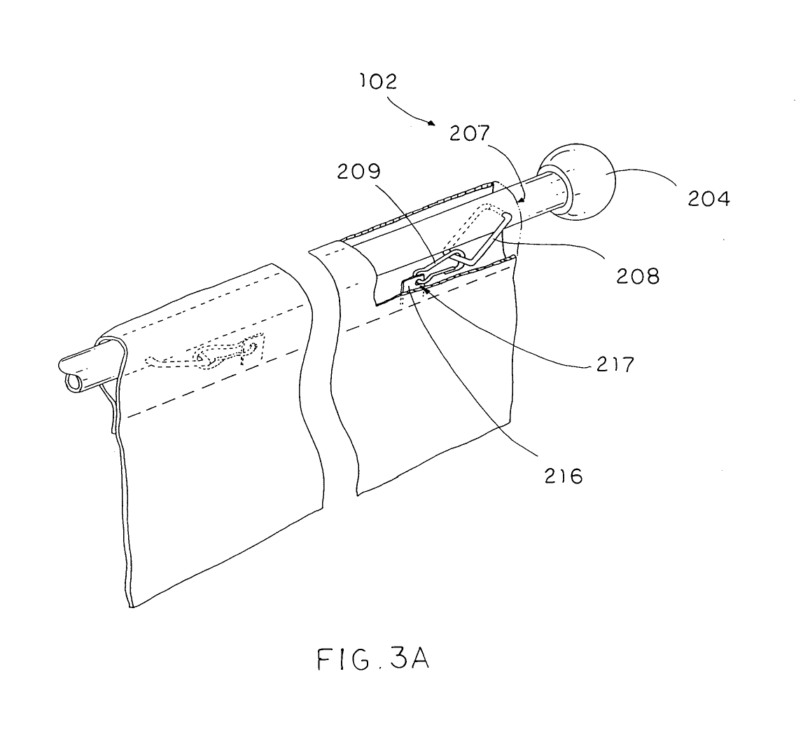

Referring to FIG. 4 of the drawings, a flag package is illustrated. The flag package comprises a plurality of decorative outdoor home flag kits 10 and a display container 301. The display container 301 further comprises a plurality of flag pockets 302 packing the flag sheet 101 therein and a container body 306 for containing the decorative outdoor home flag kits 10. The container body 306 has a front and a rear panel 303, 304 respectively and defining a displaying cavity 305 between them and a slanted top opening communicating with the displaying cavity 305. A height of the front panel 303 is shorter than a height for the rear panel 304 such that the top opening is facing frontwardly. The front and rear panel 303, 304 of the container body 306 are made of plastic for their lightweight and durable material characteristics.

FIG. 4 of the drawings illustrates the flag pocket 302 packing the flag sheet 101 therein. The flag pocket 302 provides a plastic wrapping around the flag sheet 101 which completely encloses and protects the flag sheet 101 while allowing customers to view the flat sheet 101 and the decorative graphic 103. The flag pocket 302 further comprise a hanger hook 307 disposed on a top portion of the flag pocket 302 which is made of light weight plastic adapted for hanging and suspending purpose.

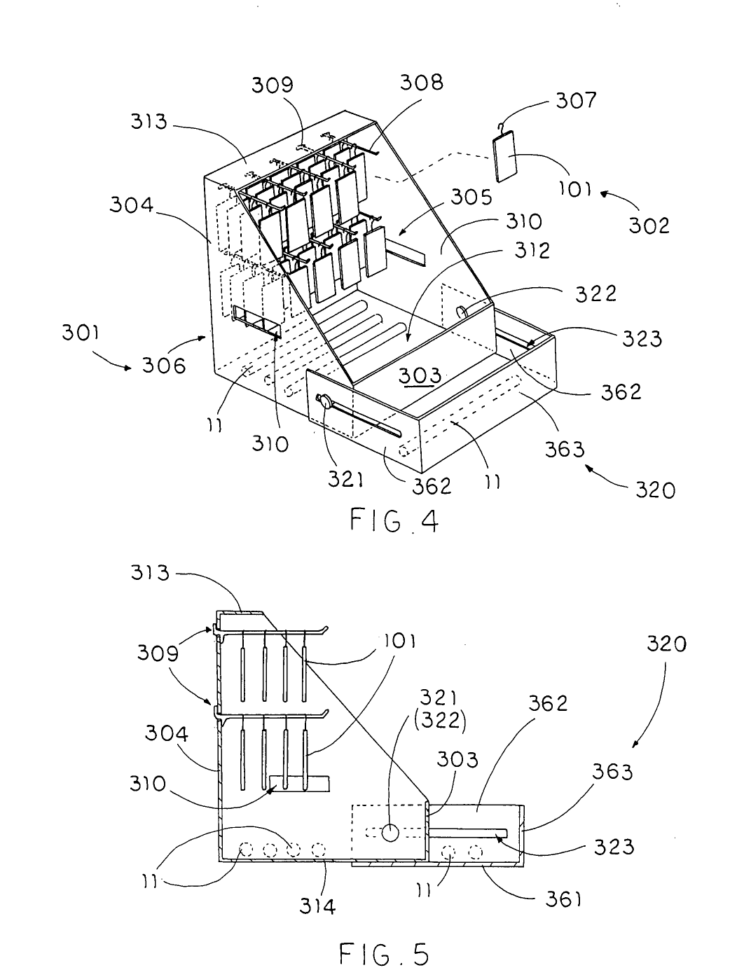

Referring to FIG. 4 of the drawings, the display container 301 further comprises a plurality of kit hangers 308 which is an elongated member extending from the rear panel 304 towards the front panel 303. Two layers of array of kits hangers 308 are mounted on the rear panel 304 as shown in FIGS. 4 and 5 of the drawings. The container body 306 further contains a set of upper hanging slots 309 alignedly formed on the rear panel 304 of the container body 306. A set of lower hanging slots 309 are alignedly formed on the rear panel 304 below the upper hanging slots, such that the kit hangers 308 are detachably coupling with the upper and lower hanging slots to suspendedly support the decorative outdoor home flag kits 10 in a double-decker manner. The hanger hook 307 of the plurality of the flag pocket 302 is adapted to be hooked and suspended on the elongated member of the kit hangers 308. As shown in FIGS. 4 and 5 of the drawings, the flag pocket 302 is able to slide freely along the kit hanger 308 such that customer can conveniently select different decorative outdoor home flag kits 10. The kit hangers 308 are aligned spacedly apart from each other such that the flag pocket 302 can be displayed in a neat manner. The display container further comprises a bottom receiving compartment 312 which is located at a bottom portion of the displaying cavity 305 at a position underneath the hanged flag pockets 302. The bottom receiving compartment 312 is used for storing the flag support frame 11 of the decorative outdoor home flag kits 10.

According to FIGS. 4 and 5 of the drawings, the container body 306 further comprises a plurality of side panels 310 and a bottom panel 311 coupling with the front and rear panel 303, 304 to form a box structure for displaying purpose. A handle slot 312 is disposed on the plurality of side panels 310 for providing a handle grip for users such that the display container 301 can be carried around conveniently. The bottom panel 311 provides a support platform for supporting the flag support frame 11 stored in the bottom receiving compartment 312.

According to FIGS. 4 and 5 of the drawings, the container body 306 further comprises a reinforcing top panel 313 communicatively connecting with the rear panel 304 and the plurality of side panels 310. Since the display container 301 is usually loaded with the plurality of the decorative outdoor home flag kits 10, a heavy loading might lead to a collapse of the container body 306. Thus the reinforcing top panel 313 is necessary to reinforce the container body 306 against the pulling downward force from the heavy loading. The reinforcing top panel 313 does not interfere with the customers reaching for the displaying cavity 305.

The display container 301 further comprises an extension storage container 320 extending outwardly from the front panel 303. The extension storage container 320 further comprises a bottom wall 361 slidably positioned underneath a bottom panel 314 of the container body 306, two sliding walls 362 slidably coupling with the side panels 310 of the container body 306 respectively, and a front wall 363 having a same height of the front panel 303 of the container body 306. A plurality of fixing pins 321 are installed on the side panels 310. The extension storage container 320 is a box shape container which provides an extended storage cavity within the front panel 303 of the container body 306, the two sliding walls 362 and the front wall 363 of the extension storage container 320. The extension storage container 320 further comprises a plurality of sliding slots 323 disposed on the sliding walls 362. A diameter of the fixing pin 321 is smaller than a height of the sliding slots 323 such that the fixing pin 321 can be fitted therewithin and the extension storage container 320 is adapted to freely slide inwardly and outwardly. A pin cap 322 is adapted to couple with the fixing pin 321 and to prevent the sliding slots 323 from slipping out of the fixing pin 321. As shown in FIGS. 4 and 5 of the drawings, when the extension storage container 320 is pulled out from the container body 306, more spaces are available for storage. This alternative embodiment provides an easy to install option for the display container 301 to be able to store extra flag support frames 11 in an easy and convenient manner.

FIG. 5 displays the cross section figure of the flag package with the decorative outdoor home flag kits 10 packed in a compact manner while the displaying cavity 305 offers a convenient way for customers to view and select the flag sheet 101 and the flag support frame 11. It is also very convenient to refill the decorative outdoor home flag kits 10 into the flag package.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A decorative outdoor home flag kit, comprising:
a flag sheet which comprises a front side displaying a decorative graphic wherein said decorative graphic is being printed on said front side by a flat screen printing method and is displayed in a reverse manner without any noticeable lost of image sharpness and color density on a rear side of said flat sheet which couples with said front side, and a flag sleeve disposed at an edge of said flag sheet;
a flag support frame suspendedly supporting said flag sheet, wherein said flag support frame comprises a suspending arm slidadbly extended along said flag sleeve and an engaging hook detachably engaging with said flag sleeve of said flag sheet so as to support said flag sheet at said suspending arm; and
an adapter coupling with said suspending arm for suspendedly supporting said flag sheet in the air.

2. The decorative outdoor home flag kit, as recited in claim 1, wherein said flat screen printing method comprises a use of a JFC permeation agent which comprises fatty alcohol epoxy ethane having a PH rate of 5.0 to 7.0.

3. The decorative outdoor home flag kit, as recited in claim 1, wherein said flat screen printing method comprises a use of a quick permeation agent T which comprises sulfonate dioctyl phthalate amber acid and having a PH rate of 6.0-7.0.

4. The decorative outdoor home flag kit, as recited in claim 1, wherein said adapter comprises an extending member detachably coupling with said suspending arm and a mounting base detachably coupling with said extending member for suspendedly supporting said flag sheet in air.

5. The decorative outdoor home flag kit, as recited in claim 4, wherein said mounting base has a upper detachable end detachably coupling with said extending member and a U-shaped lower penetrating end for penetrating to grass surface.

6. The decorative outdoor home flag kit, as recited in claim 5, wherein said suspending arm has a horizontal portion slidably extended along said flag sleeve, a vertical portion detachably coupling with said extending member, and a loop portion integrally extended from said horizontal portion to said vertical portion to reinforce a strength of said suspending arm in a L-shaped structure.

7. The decorative outdoor home flag kit, as recited in claim 1, wherein said adapter comprises a wall mount base detachably coupling with said suspending arm for mounting on a house wall so as to suspendedly support said flag sheet with respect to said house wall.

8. The decorative outdoor home flag kit, as recited in claim 7, wherein said suspending arm further comprises a flag hook at an end thereof, wherein an attachment loop is provided at said flag sheet at a position at an end of said flag sleeve to detachably engage with said flag hook so as to retain said flag sheet along said suspending arm.

9. A flag package, comprising:
a plurality of decorative outdoor home flag kits, each comprising a flat sheet, a flat support frame, and a plurality of flag pockets packing said flag sheets in a folded manner respectively; and
a display container, which comprises:
a container body having a front panel, a rear panel, and two side panels and defining a displaying cavity between said side panels and said front and rear and a slant top opening communicating with said displaying cavity, wherein a height of said front panel is shorter than a height of said rear panel such that said top opening is facing frontwardly, and
a plurality of kit hangers spacedly and frontwardly extended from said rear panel towards said front panel, wherein said flag pockets are aligned and suspended supported by said kit hangers within said displaying cavity and are arranged to face towards said top opening, wherein a bottom receiving compartment is formed at a bottom portion of said displaying cavity at a position underneath said flag pockets to receive said flag support frames within said receiving compartment such that said flag kits are packed in a compact manner and at the same time as being displayed via said display container.

10. The flag package, as recited in claim 9, wherein said container body further comprises a reinforcing top panel communicatively connecting with said rear panel and said side panels for reinforcing said container body while said decorative outdoor home flag kits are hung.

11. The flag package, as recited in claim 10, wherein said display container further comprises an extension storage container extending outwardly from said front panel, wherein said extension storage container comprises a bottom wall slidably positioned underneath a bottom panel of said container body, two sliding walls slidably coupling with said side panels of said container body respectively, and a front wall, having a same height of said front panel of said container body, arranged in such a manner that when said front wall is slid away from said front panel of said container body, said extension storage container provides an extended storage cavity within said front panel of said container body, said two sliding walls and said front wall of said extension storage container, and when said front wall of said extension storage container is slid to overlap on said front panel of said container body, said extended storage cavity is minimized to close said extension storage container.

12. The flag package, as recited in claim 11, wherein said container body further contains a handle slot formed at each of said side panels for providing a handle grip to carry said display container.

13. The flag package, as recited in claim 12, wherein said container body further comprises a set of upper hanging slots alignedly formed on an upper portion of said rear panel of said container body and a set of lower hanging slots alignedly formed on said rear panel below said upper hanging slots, wherein said kit hangers are detachably coupling with said upper and lower hanging slots to suspendedly support said decorative outdoor home flag kits in a double-decker manner.

14. The flag package, as recited in claim 13, wherein said flag sheet comprises a front side displaying a decorative graphic, wherein said decorative graphic is being printed on said front side by a flat screen printing method and is displayed in a reverse manner without any noticeable lost of image sharpness and color density on a rear side of said flag sheet which couples with said front side, wherein said flat screen printing method comprises a use of JFC permeation agent which comprises fatty alcohol epoxy ethane having a PH rate of 5.0 to 7.0.

15. The flag package, as recited in claim 13, wherein said flag sheet comprises a front side displaying a decorative graphic, wherein said decorative graphic is being printed on said front side by a flat screen printing method and is displayed in a reverse manner without any noticeable lost of image sharpness and color density on a rear side of said flag sheet which couples with said front side, wherein said flat screen printing method comprises a use of a quick permeation agent which comprise sulfonate dioctyl phthalate amber acid and having a PH rate of 6.0-7.0.

16. The flag package, as recited in claim 13, wherein said adapter comprises an extending member coupling with said suspending arm and a mounting base coupling with said extending member for suspendedly supporting said flag sheet in the air.

17. The flag package, as recited in claim 16, wherein said mounting base has an upper detachable end detachably coupling with said extending member and a U-shaped lower penetrating end for penetrating to grass surface.

18. The flag package, as recited in claim 17, wherein said suspending arm has a horizontal portion slidably extended along said flag sleeve, a vertical portion detachably coupling with said extending member, and a loop portion integrally extended from said horizontal portion to said vertical portion to reinforce a strength of said suspending arm in a L-shaped structure.

19. The flag package, as recited in claim 13, wherein said adapter comprises a wall mount base detachably coupling with said suspending arm for mounting on a house wall so as to suspendedly support said flag sheet with respect to said house wall.

20. The flag package, as recited in claim 19, wherein said suspending arm further comprises a flag hook at an end thereof, wherein an attachment loop is provided at said flag sheet at a position at an end of said flag sleeve to detachably engage with said flag hook so as to retain said flag sheet along said suspending arm.
